(19) United States
(12) Patent Application Publication
(10) Pub. No.: US 2009/0282163 A1
(43) Pub. Date: Nov. 12, 2009

(54) Communication Apparatus, Communication Method, Program and Communication System

(76) Inventor: Takanori Washiro, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/436,517

(22) Filed: May 6, 2009

(30) Foreign Application Priority Data
May 7, 2008 (JP) P2008-121409

(51) Int. Cl. G06F 15/16; H04B 5/00

(52) U.S. Cl. 709/233; 455/41.1

(57) ABSTRACT

A communication apparatus includes a communication unit, a connection establishment processing unit for exchanging connection data between the communication unit and a communication party to perform a connection establishment processing, and a communication controlling unit for statically setting a data rate of the connection data and dynamically setting a data rate of transmission data to be transmitted from the communication unit after the connection establishment processing.

### BACKGROUND OF THE INVENTION

1. Field of the Invention

The present invention relates to a communication apparatus, a communication method, a program and a communication system.

2. Description of the Related Art

In recent years, there has been broadly used a radio wave communication system prescribed in the IEEE (Institute of Electrical and Electronic Engineers) 802.11. The radio wave communication system is configured such that an antenna is used to transmit and receive a wireless radio wave, but the wireless radio wave interferes with a radio wave transmitted or received therearound, which may affect the communication.

There is proposed a communication system which uses field coupling or magnetic field coupling to make communication other than the radio wave communication system. In the communication system, for example, when a plurality of coupler for performing magnetic field coupling approach, the couplers magnetically couple so that a communication is realized between the couplers through magnetic field coupling. In this manner, according to the communication system utilizing field coupling or magnetic field coupling, since a signal is not transmitted if a communication party does not approach, an issue for the interference is difficult to occur, which is more advantageous than the radio wave communication system.

In various communication systems, typically, a data communication is started after a connection establishment processing such as authentication processing between two communication apparatuses is performed. For example, Japanese Patent No. 3669293 describes a communication system in which a connection establishment processing is performed at a lower transmission power than the data communication, thereby limiting a range in which the connection establishment processing between two communication apparatuses is enabled. Rate adaptation in which a data rate is variable depending on, for example, a situation of a communication path is applicable to various communication systems.

### SUMMARY OF THE INVENTION

However, there was an issue in the communication system in related art that when rate adaptation is applied in the connection establishment processing, even when the connection establishment processing is performed at a lower transmission power than the data communication, a range in which the connection establishment processing is enabled is enlarged or indefinite.

The present invention has been therefore made in views of the above issue, and it is desirable to provide a novel and improved communication apparatus, communication method, program and communication system capable of improving stability of a range in which a connection establishment processing is enabled.

According to an embodiment of the present invention, there is provided a communication apparatus including a communication unit, a connection establishment processing unit for exchanging connection data between the communication unit and a communication party to perform a connection establishment processing, and a communication controlling unit for statically setting a data rate of the connecting data and dynamically setting a data rate of transmission data to be transmitted from the communication unit after the connection establishment processing.

The communication controlling unit may set a data rate of the connection data to be higher than a minimum speed at the time of transmitting the transmission data.

The communication controlling unit may dynamically set a data rate of the transmission data depending on a situation of a communication with the communication party.

The communication controlling unit may statically set a data rate of the connection data such that the connection data is exchanged when the communication party is present in a limited range narrower than a maximum range in which the communication apparatus can communicate.

The communication controlling unit may dynamically set a transmission power of the transmission data and statically set a transmission power of the connection data at a lower power than a maximum power at the time of transmitting the transmission data.

The communication controlling unit may dynamically set a transmission power of the transmission data depending on a situation of a communication with the communication party.

The communication unit may communicate with the communication party through field coupling or magnetic field coupling.

According to another embodiment of the present invention, there is provided a communication method including the steps of: exchanging connection data with a communication party to perform a connection establishment processing; and transmitting transmission data to the communication party after the connection establishment processing, wherein a data rate of the connection data is statically set and a data rate of the transmission data is dynamically set.

According to another embodiment of the present invention, there is provided a program for causing a computer to function as a communication unit, a connection establishment processing unit for exchanging connection data between the communication unit and a communication party to perform a connection establishment processing, and a communication controlling unit for statically setting a data rate of the connection data and dynamically setting a data rate of transmission data to be transmitted from the communication unit after the connection establishment processing.

According to another embodiment of the present invention, there is provided a communication system including a first communication apparatus; and a second communication apparatus having a communication unit, a connection establishment processing unit for exchanging connection data between the communication unit and the first communication apparatus to perform a connection establishment processing, and a communication controlling unit for statically setting a data rate of the connection data and dynamically setting a data rate of transmission data to be transmitted from the communication unit to the first communication apparatus after the connection establishment processing.

According to the embodiments of the present invention described above, the stability of a range in which the connection establishment processing is enabled can be improved.

### BRIEF DESCRIPTION OF THE DRAWINGS

FIG. 1 is an explanatory diagram showing a communication system according to one embodiment of the present invention;

FIG. 2 is an explanatory diagram showing a variant of the communication system according to one embodiment of the present invention;

FIG. 3 is an explanatory diagram showing a comparative example of the present embodiment;

FIG. 4 is a functional block diagram showing a structure of a communication device according to the present embodiment;

FIG. 5 is an explanatory diagram showing rate adaptation;

FIG. 6 is an explanatory diagram showing a first range and a second range; and

FIG. 7 is a flowchart showing a flow of a communication method performed in the communication device according to the present embodiment.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

The “Best Mode for Carrying out the Invention” will be described according to the following items:

[1] Outline of the present embodiment

[2] How the present embodiment is made

[3] Detailed description of the present embodiment

[4] Conclusion

### [1] OUTLINE OF THE PRESENT EMBODIMENT

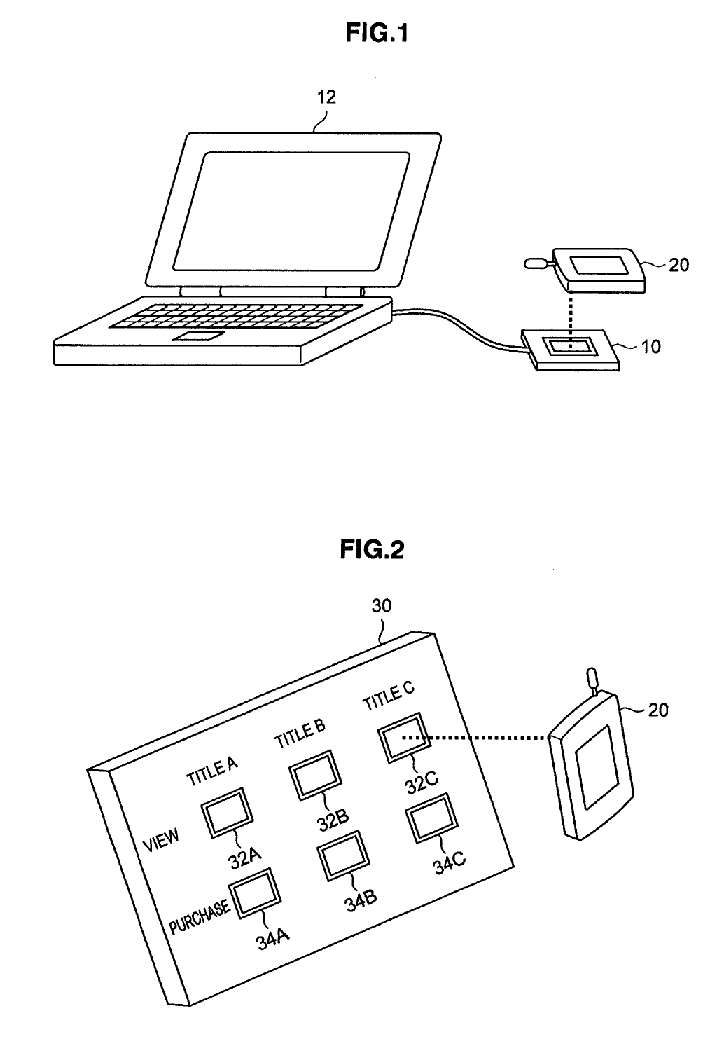

At first, an outline of a communication system according to one embodiment of the present invention will be described with reference to FIGS. 1 and 2.

FIG. 1 is an explanatory diagram showing a communication system according to one embodiment of the present invention. As shown in FIG. 1, the communication system according to the present embodiment includes a pair of devices (communication apparatuses) having a communication device 10 and a portable device 20, and an information processing device 12. Further, the communication device 10 and the portable device 20 include an electrode plate which is referred to as field coupler capable of field coupling with each other. When both field couplers of the communication device 10 and the portable device 20 approach within 3 cm, for example, a change in inductive field occurring by one field coupler is sensed by the other field coupler so that field communication is realized between the communication device 10 and the portable device 20.

Specifically, in a pair of devices for making the above field communication, one of the pair functions as an initiator and the other functions as a responder. The initiator is directed for making a connection establishment request and the responder is directed for receiving the connection establishment request from the initiator.

For example, when the portable device 20 shown in FIG. 1 functions as an initiator and the communication device 10 functions as a responder, if the portable device 20 and the communication device 10 approach each other, the communication device 10 receives a connection establishment request transmitted from the portable device 20. Then, when the connection establishment request is received by the communication device 10, the communication device 10 and the portable device 20 perform authentication processing as one example of the connection establishment processing, and when the authentication processing normally ends, the communication device 10 and the portable device 20 are connected to a state where a data communication is permitted. The authentication processing includes, for example, confirmation as to whether software versions or emulation systems indicating protocol are coincided between the communication device 10 and the portable device 20.

Thereafter, the communication device 10 and the portable device 20 make data communication in one-to-one. More specifically, the portable device 20 transmits arbitrary data to the communication device 10 by a field coupler, and the communication device 10 outputs the data received from the portable device 20 to the information processing device 12. Alternatively, arbitrary data is input from the information processing device 12 into the communication device 10, and the communication device 10 transmits the data input from the information processing device 12 to the portable device 20 by the field coupler. The arbitrary data includes music data such as music, lecture or radio program, video data such as cinema, TV program, video program, photographs, documents, pictures and graphics, or games and software.

Since a radio wave emitted from an antenna attenuates in reverse proportion to the square of the distance and the intensity of the inductive field occurring from the field coupler is reversely proportional to the fourth power of the distance, the distance between a pair of devices capable of field communication can be advantageously restricted. In other words, there can be obtained effects that deterioration in a signal due to surrounding obstacle is less in the field communication and a technique for preventing hacking or securing confidential can be simplified.

Further, a radio wave emitted from an antenna has a transverse wave component oscillating in a direction orthogonal to the radio wave traveling direction, and a polarized wave is present therein. To the contrary, since the field coupler generates an inductive field having a longitudinal wave component oscillating in the traveling direction and having no polarized wave, if the faces of the one pair of field couplers are opposed to each other, a signal can be conveniently received at the reception side.

In the present specification, there will be described an example in which a pair of communication apparatuses utilizes a field coupler to make a short distance wireless communication (non-contact communication, TransferJet), but the present invention is not limited to the example. For example, a pair of communication apparatuses can also make short distance wireless communication via a communication unit capable of communication through magnetic field coupling.

Further, the communication device 10 and the portable device 20 are merely shown as one example of the communication apparatus in FIG. 1, and the present invention is not limited to the example. For example, the communication apparatus may be an information processing device such as PC (personal computer), home video processing device (such as DVD recorder or video cassette recorder), cell phone, PHS (personal handyphone system), portable music player, portable video processing device, PDA (personal digital assistants), home game device, portable game device or household electrical appliance. Further, the communication apparatus may be a content server 30 for providing content data as shown in FIG. 2.

FIG. 2 is an explanatory diagram showing a variant of the communication system according to one embodiment of the present invention. As shown in FIG. 2, the communication system according to the variant includes the portable device 20 and the content server 30. The content server 30 stores content data therein or is connected to a content data storing device via a communication network, which provides services such as viewing and selling of the content data.

In the example shown in FIG. 2, the content server 30 includes view position displays 32A to 32C and purchase position displays 34A to 34C corresponding to the content data with title A to title C. A field coupled is provided inside each of the view position displays 32A to 32C and the purchase position displays 34A to 34C, and the content server 30 provides a service corresponding to the field coupler which the portable device 20 approaches.

For example, when the field coupler of the portable device 20 and the field coupler inside the view position display 32C approach each other, the content server 30 transmits the content data “title C” from the field coupler inside the view position display 32C to enable the portable device 20 to view it. Further, when the field coupler of the portable device 20 and the field coupler inside the purchase position display 34A approach each other, the content server 30 transmits the content data “title A” from the field coupler inside the purchase position display 34A and performs accounting.

### [2] HOW THE PRESENT EMBODIMENT IS MADE

As explained above, in the present embodiment, a data transfer is started after a connection establishment processing is performed between two communication apparatuses. Here, the distance between the two communication apparatuses capable of communication is different depending on a rate of data to be exchanged. Thus, in many cases, each communication apparatus is mounted with a function (rate adaptation) of dynamically setting a data rate depending on a situation of a communication path, for example.

According to the rate adaptation, if the distance between the two communication apparatuses is long, the data rate is lowered in order to ensure communication quality, while if the distance between the two communication apparatuses is short, the data rate is raised, thereby minimizing a data transfer time.

However, when the rate adaptation is turned ON to perform the connection establishment processing, the data rate is dynamically set so that the distance between the two communication apparatuses capable of the connection establishment processing also changes. Thus, even when a user makes the two communication apparatuses approach within the distance in which the connection establishment processing could be previously performed, the user may not perform the connection establishment processing.

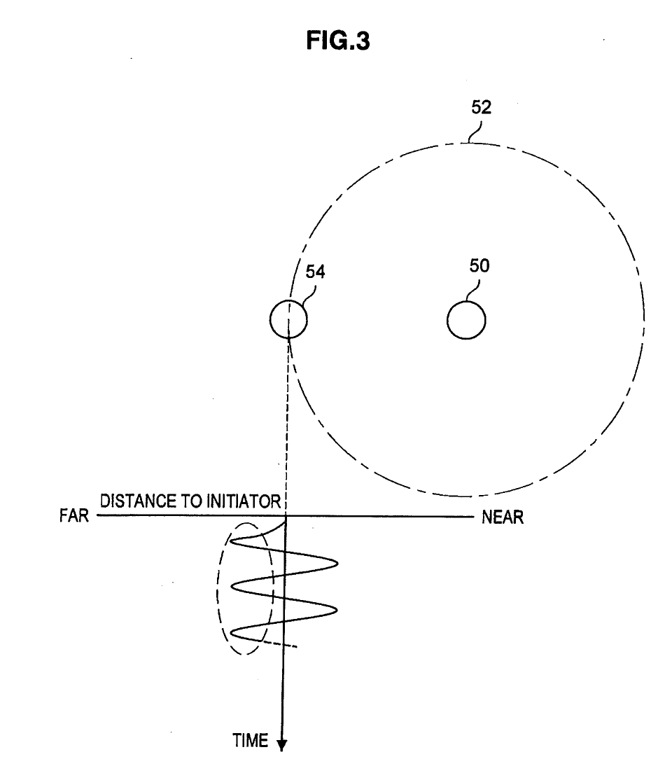

Further, when the connection establishment processing is performed at a minimum data rate, as shown in FIG. 3, the communication quality may not be ensured.

FIG. 3 is an explanatory diagram showing a comparative example of the present embodiment. FIG. 3 shows an example in which an initiator 50 and a responder 54 perform a connection establishment processing at a boundary position of a communicable range 52 at a minimum data rate of the initiator 50.

In this case, when the responder 54 is oscillated in the distance direction relative to the initiator 50, as shown by a dotted-lined ellipse in FIG. 3, the responder 54 is not included in the communicable range 52 of the initiator 50. Consequently, the data transfer is interrupted between the responder 54 and the initiator 50, which causes an issue in which the communication quality is not ensured unlike with the above.

In the radio wave communication system using an antenna, since attenuation due to the radio wave distance is gentle, it was difficult to enlarge the difference in the signal intensity between long distance and short distance. Further, since the signal intensity depends on not only the distance but also the orientation of the polarized wave and is influenced by the multipath, even when the two communication apparatuses approach each other, null may occur. Thus, also in the radio wave communication system using an antenna, it was difficult to start the connection establishment processing by a trigger in which the two communication apparatuses are within a certain distance.

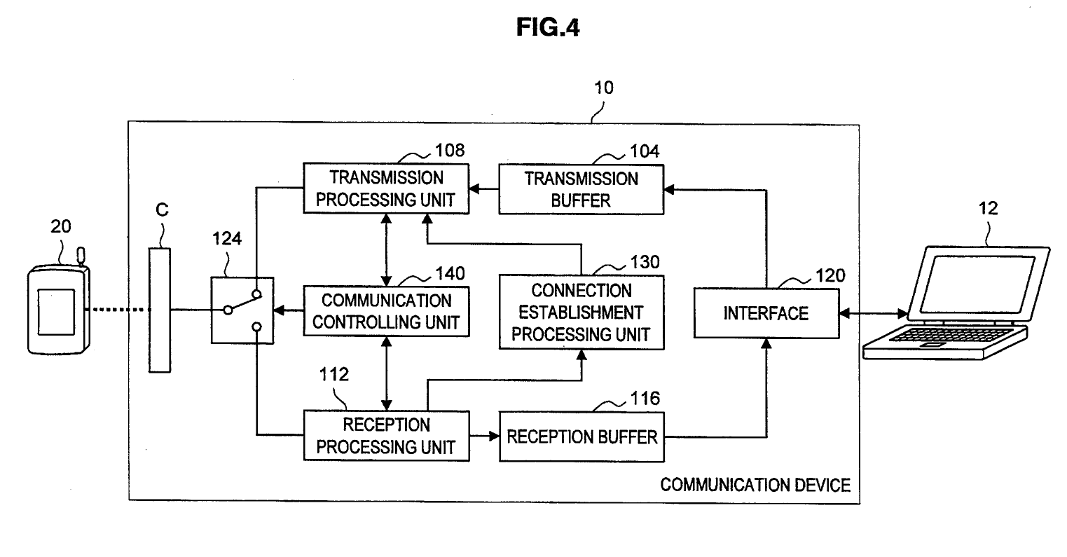

Thus, the present embodiment has been made in terms of the above circumstances. According to the present embodiment, it is possible to improve the stability of a range in which the connection establishment processing is enabled and the communication quality of the data transfer. Hereinafter, the present embodiment will be explained in detail with reference to FIGS. 4 to 7.

### [3] DETAILED DESCRIPTION OF THE PRESENT EMBODIMENT

FIG. 4 is a functional block diagram showing a structure of the communication device 10 according to the present embodiment. As shown in FIG. 4, the communication device 10 includes a field coupler C, a transmission buffer 104, a transmission processing unit 108, a reception processing unit 112, a reception buffer 116, an interface 120, a selector 124, a connection establishment processing unit 130 and a communication controlling unit 140. There will be explained below an example in which the communication device 10 functions as an initiator and the portable device 20 functions as a responder.

The field coupler C functions as a communication unit for making communication with the field coupler of the neighboring portable device 20 through field coupling as explained in “[1] Outline of the present embodiment”. Further, the field coupler C is selectively connected to the transmission processing unit 108 or the reception processing unit 112 via the selector 124.

The transmission buffer 104 is a storing medium which holds therein transfer data (transmission data) to be transferred from the field coupler C to the portable device 20. The transfer data is input into the transmission buffer 104 from the information processing device 12 via the interface 120.

The transmission buffer 104 may be a storing medium including a non-volatile memory such as EEPROM (Electrically Erasable Programmable Read-Only Memory) or EPROM (Erasable Programmable Read-Only Memory), magnetic disk such as hard disk or disk-shaped magnetic disk, optical disk such as CD-R (Compact Disc Recordable)/RW (ReWritable), DVD-R (Digital Versatile Disc Recordable)/RW/+R/+RW/RAM (Random Access Memory) and BD (Blu-Ray Disc (registered trademark))-R/BD-RE, or MO (Magneto Optical) disk. Further, the function of the transmission buffer 104 may be mounted on the same storing medium in its function as the reception buffer 116 described later.

The transmission processing unit 108 performs a signal processing for converting transfer data input from the transmission buffer 104 or connection data such as connection establishment request input from the connection establishment processing unit 130 into a signal form which is transmittable from the field coupler C. More specifically, the transmission processing unit 108 performs the signal processing such that the input data is transmitted from the field coupler C at a data rate set by the communication controlling unit 140.

The reception processing unit 112 performs a decode processing on data received by the field coupler C. For example, the reception processing unit 112 may down-convert the data received by the field coupler C as a high frequency signal into a baseband signal to acquire a bit string based on constellation.

The reception buffer 116 is a storing medium holding therein the data decoded by the reception processing unit 112. The data held in the reception buffer 116 is output to the information processing device 12 via the interface 120.

The interface 120 inputs/outputs the data into/from the information processing device 12. Specifically, the interface 120 may have a wireless communication function prescribed in the IEEE (Institute of Electrical and Electronic Engineers)802.11a, b, g or MIMO (Multiple Input Multiple Output) communication function prescribed in the IEEE 802.11n.

Further, the interface 120 may have a communication function corresponding to WiMAX (Worldwide Interoperability for Microwave Access) prescribed in the IEEE 802.16. The interface 120 may have a communication function corresponding to wired LAN prescribed in the IEEE 802.3 or may have USB (Universal Serial Bus) communication function.

The selector 124 selectively connects the field coupler C and either the transmission processing unit 108 or the reception processing unit 112 based on the control by the communication controlling unit 140. More specifically, the field coupler C is connected to the transmission processing unit 108 via the selector 124 at the time of transmission of the communication device 10, and the field coupler C is connected to the reception processing unit 112 via the selector 124 at the time of reception of the communication device 10.

The connection establishment processing unit 130 performs the connection establishment processing needed when performing data transfer between the communication device 10 and the portable device 20. For example, since the communication device 10 functions as an initiator, a connection establishment request is output to the transmission processing unit 108, and the connection establishment request is transmitted from the field coupler C when the portable device 20 and the field coupler C approach. An approach between the portable device 20 and the field coupler C may be detected when the field coupler C receives a signal having equal to or more than a predetermined signal intensity. Further, the connection establishment request may include a software version of the communication device 10 or an emulation system representing protocol.

Then, the portable device 20 determines whether the software version or emulation system included in the connection establishment request are coincide with those of the self device, and if coincided, may transmit ACK indicating the coincidence to the communication device 10. When a series of connection establishment processings ends between the communication device 10 and the portable device 20, the communication device 10 and the portable device 20 are connected to a state in which a data transfer is enabled. The above description merely shows an example of the connection establishment processing and an arbitrary connection establishment processing can be applied to the present embodiment.

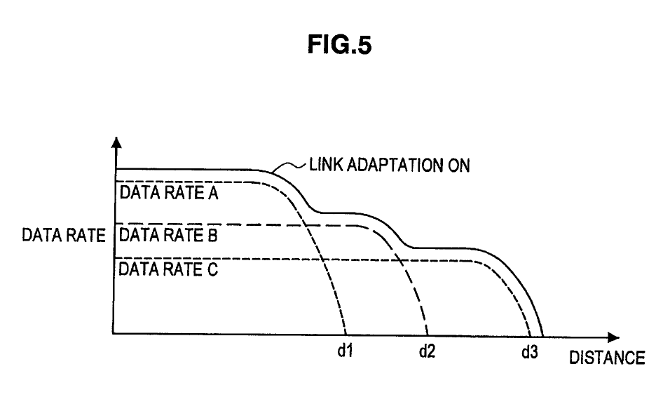

When the connection establishment processing ends and the data transfer is started, the communication controlling unit 140 turns ON the rate adaptation. Therefore, the transmission processing unit 108 performs dynamic signal processing on the transfer data to attain a data rate instructed by the communication controlling unit 140 at the time of the data transfer. Here, the rate adaptation will be explained with reference to FIG. 5.

FIG. 5 is an explanatory diagram showing rate adaptation. As shown in FIG. 5, when the data transfer is performed at a data rate B, the communication quality can be maintained until the distance d2. To the contrary, when the data transfer is performed at a higher data rate A than the data rate B, the communication quality is maintained only until the distance d1 shorter than the distance d2.

When the data transfer is performed at a lower data rate C than the data rate B, the communication quality is maintained until the distance d3 longer than the distance d2. In this manner, it is known that as the data rate is higher, the distance within which the communication quality can be maintained is shorter, and as the data rate is lower, the distance within which the communication quality can be maintained is longer.

There is proposed rate adaptation as a method for improving an efficiency of the data transfer by dynamically setting a data rate based on the situation such as communication distance. If the rate adaptation is turned ON, as indicated by a solid line in FIG. 5, the data rate A is applied until the distance d1, the data rate B is applied from the distance d1 to d2, and the data rate C is applied from the distance d2 to d3. In other words, when the rate adaptation is turned ON, the data transfer can be performed at the maximum data rate at which the communication quality is maintained at a present distance, thereby minimizing the total data transfer time.

Specifically, the transmission processing unit 108 can dynamically vary the data rate by changing a spreading ratio (a ratio of spread code speed “chip rate” to transfer data speed “bit rate”) in the spectrum spreading system. For example, if the transmission power is the same, when the spreading ratio is low, the data rate is large so that the data transfer efficiency is enhanced, but the communicable distance is shortened. Further, when the spreading ratio is high, the data rate is small so that the data transfer efficiency is lowered, but the communicable distance is made longer. The communication controlling unit 140 can perform the data rate setting depending on a reception intensity of a signal received from the portable device 20, a reception error rate (packet error rate) of the transfer data in the portable device 20 or the like.

The communication controlling unit 140 according to the present embodiment turns ON the rate adaptation described above at the time of the data transfer and turns OFF at the time of the connection establishment processing. In other words, the data rate is dynamically set at the time of the data transfer and the data rate is statically set at the time of the connection establishment processing. Thus, since the user makes the communication device 10 and the portable device 20 approach within a certain distance so that the connection establishment processing is started, the user can expect the same operation (connection establishment processing) by the communication device 10 and the portable device 20 by performing the same operation. On the other hand, since the rate adaptation is turned ON at the time of the data transfer, the optimum data rate is selected depending on the distance between the communication device 10 and the portable device 20 or the communication situation, thereby restricting the data transfer time to the minimum.

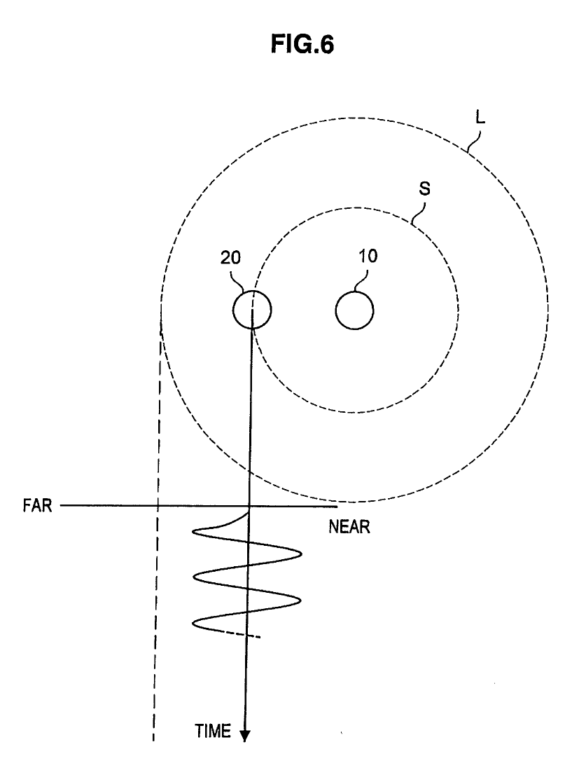

Further, the communication controlling unit 140 may fixedly set the data rate at the time of the connection establishment processing at a predetermined data rate higher than the minimum data rate at the time of the data transfer. For example, when the data rates A to C shown in FIG. 5 can be dynamically set at the time of the data transfer, the communication controlling unit 140 may set the data rate A or the data rate B at the time of the connection establishment processing. With the structure, as shown in FIG. 6, the stability of the data transfer by the communication device 10 and the portable device 20 can be improved.

FIG. 6 is an explanatory diagram showing a first range S and a second range L. The second range L is a maximum range in which the communication device 10 can communicate (that is, a range in which the communication quality can be maintained at the minimum data rate). On the other hand, the first range S is a limited range narrower than the second range L in which the communication quality is maintained at a predetermined data rate higher than the minimum data rate.

As described above, since the data rate at the time of the connection establishment processing is set at the predetermined data rate higher than the minimum data rate, the connection establishment processing unit 130 can perform the connection establishment processing when the portable device 20 is present within the first range S.

Thus, as shown in FIG. 6, even if the distance between the portable device 20 and the communication device 10 varies, the communication controlling unit 140 turns ON the rate adaptation so that the communication device 10 can continuously maintain the data transfer to the portable device 20. In other words, more stable data transfer can be realized according to the present embodiment. The communication controlling unit 140 turns OFF the rate adaptation again after the data transfer ends, and prepares the next connection establishment processing.

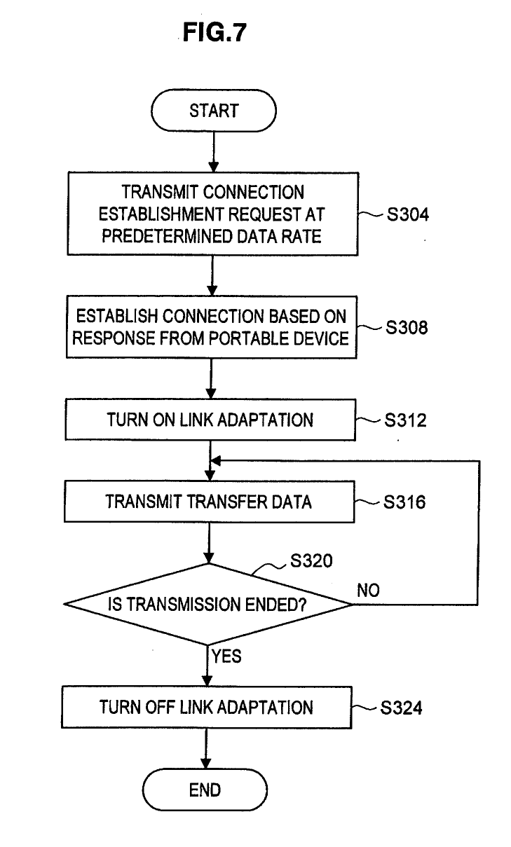

Next, a flow of the communication method performed by the communication device 10 according to the present embodiment will be explained with reference to FIG. 7.

FIG. 7 is a flowchart showing a flow of the communication method performed in the communication device 10 according to the present embodiment. As shown in FIG. 7, at first, the communication device 10 transmits a connection establishment request to the portable device 20 at a fixed predetermined data rate set by the communication controlling unit 140 (S304). Then, the connection establishment processing unit 130 in the communication device 10 establishes a connection with the portable device 20 based on the response for the connection establishment request from the portable device 20 (S308).

Thereafter, the communication controlling unit 140 turns ON the rate adaptation (S312), the transmission processing unit 108 performs signal processing on transfer data at a dynamically-set data rate, and the field coupler C transmits the transfer data which has been subjected to the signal processing (S316). Then, when the transmission of the transfer data ends (S320), the communication controlling unit 140 turns OFF the rate adaptation (S324) and a series of processings is terminated.

### [4] CONCLUSION

As described above, the communication device 10 according to the present embodiment turns OFF the rate adaptation to perform the connection establishment processing, and turns ON the rate adaptation to perform the data transfer. With the structure, since the user makes the communication device 10 and the portable device 20 approach within a certain distance so that the connection establishment processing is started, the user can expect the same operation (connection establishment processing) by the communication device 10 and the portable device 20 by performing the same operation. On the other hand, since the rate adaptation is turned ON at the time of the data transfer, the optimum data rate is selected depending on the distance between the communication device 10 and the portable device 20 or the communication situation, thereby restricting the data transfer time to the minimum.

Furthermore, in the present embodiment, the data rate at the time of the connection establishment processing is set at a predetermined data rate higher than the minimum data rate at the time of the data transfer. Thus, a range in which the connection establishment processing is permitted is limited by the range in which the data transfer is permitted. Consequently, even when the distance between the portable device 20 and the communication device 10 is far away after the connection establishment processing, the communication device 10 can continuously maintain the data transfer to the portable device 20 if it is within the range in which the data transfer is permitted. In other words, according to the present embodiment, more stable data transfer can be realized.

Furthermore, since the field coupler C is utilized in the present embodiment, the amount of change in the field relative to the distance is larger than in the antenna using a radiation electromagnetic field. Consequently, the distance between the two communication apparatuses can be made more fixedly within which the connection establishment processing by the two communication apparatuses is started.

It should be understood by those skilled in the art that various modifications, combinations, sub-combinations and alterations may occur depending on design requirements and other factors insofar as they are within the scope of the appended claims or the equivalents thereof.

For example, there has been explained above the example in which the fixedly installed communication device 10 switches ON and OFF the rate adaptation, but the portable device 20 may switch ON or OFF the rate adaptation when the data transfer is performed from the portable device 20. Further, when the portable device 20 receives the connection establishment request transmitted at the predetermined data rate, the portable device 20 may transmit a response for the connection establishment request at the fixed data rate similarly as the communication device 10.

There has been explained above the example in which the rate adaptation is switched ON and OFF at the time of the connection processing and at the time of the data transfer, but the present invention is not limited to the example. For example, the communication controlling unit 140 may further switch the transmission power between at the time of the connection processing and at the time of the data transfer.

More specifically, the communication controlling unit 140 may fixedly set the transmission power at the time of the connection processing to be lower than the maximum power at the time of the data transfer. With the structure, the distance between the portable device 20 and the communication device 10 within which the connection processing is enabled can be more limited as compared with the distance between the portable device 20 and the communication device 10 within which the data transfer is enabled, thereby further improving the stability of the data transfer.

On the other hand, the communication controlling unit 140 switches the transmission power depending on the situation of the communication path at the time of the data transfer, for example, increases the transmission power when the situation of the communication path is bad, and decreases the transmission power when the situation of the communication path is good, thereby maintaining the communication quality while reducing the consumption power.

Further, each step in the processing of the communication device 10 in the present specification does not necessarily need to be processed in time line in the order described in the flowchart. For example, each step in the processing of the communication device 10 may include a processing performed in parallel or individually (such as parallel processing or object processing).

Furthermore, there can be created a computer program for causing hardware such as CPU, ROM and RAM incorporated in the communication device 10 and the portable device 20 to exhibit a similar function as each structure of the communication device 10 described above. There is also provided a storing medium in which the computer program is stored. The respective functional blocks illustrated in the functional block diagram of FIG. 4 are configured in hardware, thereby realizing a series of processings in hardware.

The present application contains subject matter related to that disclosed in Japanese Priority Patent Application JP 2008-121409 filed in the Japan Patent Office on May 7, 2008, the entire content of which is hereby incorporated by reference.

What is claimed is:

1. A communication apparatus comprising:
a communication unit;
a connection establishment processing unit for exchanging connection data between the communication unit and a communication party to perform a connection establishment processing; and
a communication controlling unit for statically setting a data rate of the connection data and dynamically setting a data rate of transmission data to be transmitted from the communication unit after the connection establishment processing.

2. The communication apparatus according to claim 1, wherein the communication controlling unit sets a data rate of the connection data at a higher data rate than a minimum speed at the time of transmitting the transmission data.

3. The communication apparatus according to claim 2, wherein the communication controlling unit dynamically sets a data rate of the transmission data depending on a situation of a communication with the communication party.

4. The communication apparatus according to claim 1, wherein the communication controlling unit statically sets a data rate of the connection data such that the connection data is exchanged when the communication party is present within a narrower limited range than a maximum range in which the communication apparatus is communicable.

5. The communication apparatus according to claim 1, wherein the communication controlling unit dynamically sets a transmission power of the transmission data, and statically sets a transmission power of the connection data to be lower than a maximum power at the time of transmitting the transmission data.

6. The communication apparatus according to claim 5, wherein the communication controlling unit dynamically sets a transmission power of the transmission data depending on a situation of a communication with the communication party.

7. The communication apparatus according to claims 1 to 6, wherein the communication unit makes communication with the communication party through field coupling or magnetic filed coupling.

8. A communication method comprising the steps of:
exchanging connection data with a communication party to perform a connection establishment processing; and
transmitting transmission data to the communication party after the connection establishment processing,
wherein a data rate of the connection data is statically set and a data rate of the transmission data is dynamically set.

9. A program for causing a computer to function as:
a communication unit;
a connection establishment processing unit for exchanging connection data between the communication unit and a communication party to perform a connection establishment processing; and
a communication controlling unit for statically setting a data rate of the connection data and dynamically setting a data rate of transmission data to be transmitted from the communication unit after the connection establishment processing.

10. A communication system comprising:
a first communication apparatus; and
a second communication apparatus including:
a communication unit;
a connection establishment processing unit for exchanging connection data between the communication unit and the first communication apparatus to perform a connection establishment processing; and
a communication controlling unit for statically setting a data rate of the connection data and dynamically setting a data rate of transmission data to be transmitted from the communication unit to the first communication apparatus after the connection establishment processing.
